(19) United States
(12) Patent Application Publication
(10) Pub. No.: US 2015/0272364 A1
(43) Pub. Date: Oct. 1, 2015

(54) CLOTHES HANGER

(71) Applicant: Rory Brendan LARSEN, Birkenhead, Auckland (NZ)

(72) Inventor: Rory Brendan Larsen, Auckland (NZ)

(21) Appl. No.: 14/440,961

(22) PCT Filed: Oct. 31, 2013
(86) PCT No.: PCT/NZ2013/000194

§ 371 Date: May 6, 2015

(30) Foreign Application Priority Data
Nov. 6, 2012 (NZ) 602865
Mar. 1, 2013 (NZ) 607746
Mar. 22, 2013 (NZ) 608601
Jul. 3, 2013 (NZ) 612767
Aug. 14, 2013 (NZ) 614302

(51) Int. Cl. A47G 25/14; A47G 25/48; G09G 3/32; A47B 61/00

(52) U.S. Cl. CPC A47G 25/1407; A47B 61/00; A47G 25/48; G09G 3/32; G09G 2380/04

(57) ABSTRACT

This invention relates to a clothes hanger for supporting an item of clothing. The clothes hanger includes a hanging means for hanging the clothes hanger from a support means, and further includes an electronic display device located in the region of the neck portion 5 of the clothes hanger, the electronic display device including a viewing screen adapted to display promotional and/or informational material. The arrangement and construction is such that the electronic display device is adapted to be activated, or activatable, upon the clothes hanger being removed from the support means by a user.

### FIELD

This invention relates to a clothes hanger.

In particular, the invention relates to a clothes hanger which includes an electronic display device which may be used for displaying promotional and/or informational material.

The clothes hanger may be particularly suitable for supporting an item of clothing, such as a garment, and for convenience only therefore the invention will be predominantly described in relation to such use. However, it is to be understood and appreciated that the invention may also have other users or applications. The prior art, and possible applications of the invention, as described below, are therefore given by way of example only.

### BACKGROUND

Clothes hangers are well known, and are usually used for the hanging of garments such as shirts, sweaters, jackets, blouses, dresses, trousers, skirts, and so on.

Most clothes hangers include two arms, joined at a central neck portion, where a hanging hook is usually fitted.

Many clothes hangers also include a horizontal crossbar, extending between the distal ends of the two arms, with the crossbar being used for hanging garments such as trousers therefrom.

Furthermore, the ends of the two arms, and/or the horizontal crossbar extending therebetween, are sometimes fitted with clips, which may be used to clip onto garments to be hung therefrom (rather than, or in addition to, garments hanging from the arms and/or the crossbar of the clothes hanger).

Most clothes hangers are made from wire, wood or plastic, or combinations of these materials.

In a retail clothing environment, clothes hangers are used to hang garments on clothing racks, where they may be viewed by customers. Upon a customer viewing a garment that he/she potentially likes, the customer will remove the clothes hanger holding the garment from the rack in order to further study the garment, before deciding whether to purchase the garment, or (more likely) whether to try the garment on before deciding whether to purchase the garment.

However, conventional clothes hangers offer no promotional and/or informational assistance to the customer during the important time of inspection of the garment and/or during the time the customer is deciding whether to try the garment on (and ultimately therefore whether to purchase the garment). That is, the function of conventional clothes hangers is merely to hang garments on a clothing rack for viewing by customers.

U.S. Pat. No. 5,738,255 (Wilms) describes a clothes hanger with an electronic information storage device which can hold clothing-specific data. The data collected and/or stored may include data such as the clothing manufacturer, the garment size, the price, the clothing material, the number of times the garment has been tried on, and so on. The data may also include details relating to the clothes hanger, for example the type, year of manufacture, and material of construction.

However, a disadvantage associated with Wilms is that the data in the electronic information storage device may only be accessed by the use of a special reading gun. The reading gun may be made available in each changing room, together with a monitor for displaying the data. Hence, the cost and logistics of providing a large number of reading guns and/or monitors for a large number of customers, and/or changing rooms, may be prohibitively expensive for a retailer.

Furthermore, the data contained within the electronic information storage device is read-only. Hence, the electronic information storage device, and/or the data contained therein, is not designed to be interactive with respect to the customer. That is, the customer is merely able to view the data, rather than (for example) being able to choose between different types of data to be displayed and/or choose between a range of viewing options for displaying the data.

Furthermore, the clothes hanger described in Wilms does not allow for the automatic display of the data contained in the electronic information storage device. For example, it does not allow for the automatic display of data upon a customer removing the clothes hanger from the clothing rack. Instead, the customer is only able to view the data with the use of a specialised reading gun, and only then in a specific area, namely a changing room.

EP 2 538 385 (Team Lab Inc.) describes a clothes hanger which includes a digital signage system. The digital signage system comprises a sensor mounted on the clothes hanger which can automatically sense when, and how long, the clothes hanger has been taken off a clothing rack by a customer (eg, for viewing purposes). The data gathered may be transmitted wirelessly from the clothes hanger to a computer. Furthermore, images of the garment can be displayed on a monitor in the vicinity of the customer.

However, a disadvantage of the clothes hanger described in EP 2 538 385 is that images of the garment can only be displayed on a monitor in the vicinity of the customer, rather than being displayed on the clothes hanger itself. Hence, a clothing retailer must ensure that its store is outfitted with a large number of monitors, which may be a prohibitively expensive consideration for the retailer.

Furthermore, if there are a large number of customers in the store, this may create a backlog of customers waiting to view their garment(s) on the monitor(s). This wait may be frustrating for customers, and/or may result in some customers becoming impatient and leaving the store.

Moreover, if a large numbers of monitors are present in the store, the customer may be confused as to which monitor is specific to them, and/or to the garment they have removed from the rack. Furthermore, if a large part of the store is taken up by monitors, this means that the store owner may have less space for its clothing racks and/or less space for in-store advertising or for displaying its own general promotional and/or informational material.

Furthermore, the digital signage system of EP 2 538 385 is primarily designed to be a data gathering exercise for the retailer, rather than for displaying promotional and/or informational material for the customer. That is, the digital signage system primarily serves to collect data such as when, and how long, a clothes hanger has been taken off a rack by a customer. In this fashion, a retailer may determine which garments are the most popular, at least for viewing purposes. And so, the customer is not able to view any other data or information relating to the garment, for example clothing-specific data.

Moreover, the digital signage system is not designed to be interactive with the customer. That is, and as per Wilms also, the customer is merely able to view the relevant information or data rather than (for example) being able to choose between different types of information to be displayed and/or choose between a range of viewing options for displaying the information.

A further disadvantage, or limitation, associated with the inventions described in both Wilms and EP 2 538 385 is that both clothes hangers do not allow for an electronic display, for example a visual and/or audio display, on the clothes hangers themselves. Instead, any information is displayed on a remote or adjacent monitor.

### OBJECT

It is an object of the present invention to provide a clothes hanger which goes some way towards addressing one or more of the above problems or difficulties, or which at the very least provides the public with a useful choice.

### DEFINITIONS

Throughout this specification unless the text requires otherwise, the word ‘comprise’ and variations such as ‘comprising’ or ‘comprises’ will be understood to imply the inclusion of a stated integer or step or group of integers or steps but not the exclusion of any other integer or step or group of integers or steps.

### STATEMENTS OF INVENTION

According to one aspect of the present invention, there is provided a clothes hanger for supporting an item of clothing, said clothes hanger including:
a) two arms extending from a neck portion, said arms and/or neck portion being adapted, or able, to support said item of clothing,
b) a hanging means connected, or connectable, to the neck portion for hanging the clothes hanger from a support means,
c) an electronic display device located in the region of the neck portion of the clothes hanger, said electronic display device including a viewing screen adapted to display promotional and/or informational material,
   the arrangement and construction being such that said electronic display device is adapted to be activated, or activatable, upon the clothes hanger being removed from said support means by a user.

According to another aspect of the present invention, there is provided a clothes hanger, substantially as described above, the clothes hanger is further provided with a crossbar extending between the distal ends of the two arms.

According to another aspect of the present invention, there is provided a clothes hanger, substantially as described above, wherein the arms, neck portion and crossbar are formed from a single piece of material.

According to another aspect of the present invention, there is provided a clothes hanger, substantially as described above, wherein the crossbar and/or the distal ends of the arms are provided with one or more clips for clipping onto the item to be supported.

According to another aspect of the present invention, there is provided a clothes hanger, substantially as described above, wherein the electronic display device includes, or is in communication with, a central processing unit (CPU).

According to another aspect of the present invention, there is provided a clothes hanger, substantially as described above, wherein the electronic display device is integrally formed with respect to the clothes hanger.

According to another aspect of the present invention, there is provided a clothes hanger, substantially as described above, wherein the electronic display device is adapted to activate automatically upon a customer picking up the clothes hanger, and/or removing the clothes hanger, from the support means.

According to another aspect of the present invention, there is provided a clothes hanger, substantially as described above, wherein the electronic display device is adapted, or able, to be activated manually by a customer.

According to another aspect of the present invention, there is provided a clothes hanger, substantially as described above, wherein the operation of the electronic display device is able to be controlled by the customer, whereby the customer is able to determine the type of promotional and/or informational material to be displayed on the electronic display device and/or choose between a range of viewing options.

According to another aspect of the present invention, there is provided a clothes hanger, substantially as described above, wherein the viewing screen is a touchscreen.

According to another aspect of the present invention, there is provided a clothes hanger, substantially as described above, wherein the clothes hanger and/or the electronic display device is further provided with audio output capabilities.

According to another aspect of the present invention, there is provided a clothes hanger, substantially as described above, wherein the clothes hanger and/or the electronic display device includes data collection capabilities.

According to another aspect of the present invention, there is provided a clothes hanger, substantially as described above, wherein the clothes hanger and/or the electronic display device includes data receipt and/or data transmission capabilities.

According to another aspect of the present invention, there is provided a clothes hanger, substantially as described above, wherein the clothes hanger and/or the electronic display device includes a wireless transceiver.

According to another aspect of the present invention, there is provided a clothes hanger, substantially as described above, wherein the promotional and/or informational material to be displayed by the electronic display device relates to the item supported by the clothes hanger.

According to another aspect of the present invention, there is provided a clothes hanger, substantially as described above, wherein the support means is a clothing rack.

According to another aspect of the present invention, there is provided a clothes hanger, substantially as described above, wherein the hanging means is a hook.

According to another aspect of the present invention, there is provided a clothes hanger, substantially as described above, wherein the electronic display device includes a rechargeable battery.

According to another aspect of the present invention, there is provided a clothes hanger, substantially as described above, wherein the hook includes two or more electrically isolated contacts adapted to engage with corresponding conductive elements of the clothing rack, to enable the recharging of the rechargeable battery.

According to another aspect of the present invention, there is provided a clothes hanger, substantially as described above, wherein the battery is adapted to be recharged wirelessly and/or via inductive recharging.

According to another aspect of the present invention, there is provided a clothes hanger, substantially as described above, wherein the clothes hanger further includes a detection system for determining if an item of clothing is being supported by the clothes hanger.

According to another aspect of the present invention, there is provided a clothes hanger, substantially as described above, wherein the clothes hanger further includes a proximity sensor to detect if a person is in the vicinity of the clothes hanger.

According to another aspect of the present invention, there is provided a clothes hanger, substantially as described above, wherein the proximity sensor is adapted to activate a display light or lights if a person is detected as being in the vicinity of the clothes hanger.

The clothes hanger may be particularly suitable for supporting an item of clothing, such as a garment, and for convenience only therefore the invention will be predominantly described in relation to such use. However, it is to be understood and appreciated that the invention may also have other users or applications, for example in relation to supporting items such as fashion accessories, for example handbags, ties, belts, watches, footwear, jewelry, umbrellas, and so on.

The clothes hanger may preferably include two arms extending from a neck portion, the arms and/or neck portion being adapted, or able, to support an item of clothing, such as a garment.

The clothes hanger may preferably also include a hanging means connected, or connectable, to the neck portion for hanging the clothes hanger from a suitable support means.

Preferably, there may also be provided an electronic display device located in the region of the neck portion of the clothes hanger, the electronic display device preferably including a viewing screen adapted to display promotional and/or informational material. The arrangement and construction may preferably be such that electronic display device is adapted to be activated, or activatable, upon the clothes hanger being removed from the support means by a user.

In one embodiment, the two arms may be formed separately and attached to the neck portion.

Preferably however, the two arms and neck portion may be integrally formed.

The two arms essentially form the shoulders of the clothes hanger, and may be of any suitable shape or configuration.

In one embodiment, the clothes hanger may further include a crossbar extending between the distal ends of the two arms. In such an embodiment, the crossbar may be utilised for hanging garments such as trousers (possibly in conjunction with another garment being hung from the arms and/or neck portion of the clothes hanger).

Furthermore, the crossbar and/or the distal ends of the arms may be provided with clips for clipping onto garments to be hung therefrom. In such an embodiment, another garment may also be hung from the arms and/or neck portion of the clothes hanger.

The neck portion is defined as being the region anywhere between the distal ends of the two arms, and including the bottom (and/or crossbar) of the clothes hanger.

Any suitable hanging means for hanging the clothes hanger from the support means may be utilised, as required or as desired, or as dictated by the intended use of the clothes hanger.

For example, the hanging means may be in the form of a hook-shaped portion connected, or connectable, to the neck portion.

Alternatively, the hanging means may be in the form of a rod extending from the neck portion, with the distal end of the rod being provided with a lug for engaging with a corresponding hook which may be permanently attached to a support means. Such arrangements are commonly found in a hotel room closets and are designed to ensure that clothes hangers are not stolen or inadvertently taken.

The hanging means may be integrally formed with respect to the neck portion.

Any suitable support means may be utilised which is adapted, or able, to accommodate the hanging means. For example, the support means may be a hook, rod, rail or rack, and preferably a clothing rack such as a retail clothing rack. In such an embodiment, the rail may be manufactured in such a way that the rail may be extendible. For example, one half of the rail may slide inside the other half of the rail, thus making it extendible (for example) between shelf partitions for user-friendly installation.

In one embodiment the electronic display device may be located on only one side of the clothes hanger.

Alternatively, the electronic display device may be located on both sides of the clothes hanger. In such an embodiment, both sides of the electronic display device may be adapted to display the same promotional and/or informational material. Alternatively, each side of the electronic display device may be adapted to display different promotional and/or informational material. Furthermore, only one of the two sides may be chosen to display the promotional and/or informational material (with the other side of the electronic display device being blank—until activated).

In one embodiment, the electronic display device may be integrally formed with respect to the clothes hanger.

In an alternative embodiment, the electronic display device may be fitted to an existing clothes hanger and/or be releasably attachable with respect to the clothes hanger.

Preferably, the electronic display device may include, or be in communication with, a central processing unit (CPU).

Preferably, the CPU may comprise part of, or be embedded within, the electronic display device.

The CPU may control the overall operation of the electronic display device.

For example, the CPU may control the overall functions and/or workings of the electronic display device, as well as the loading, playing, removal and overall use of the promotional and/or informational material to be displayed on the electronic display device.

Preferably, the clothes hanger and/or the CPU and/or the electronic display device may include data collection and/or data receipt and/or data transmission capabilities.

For example, the data collection capabilities may collect data relating to the use of the clothes hanger and/or the electronic display device and/or how the promotional and/or informational material is utilised by a customer.

Furthermore, and for example, the data transmission capabilities may enable any, or all, such data collected to be transmitted to a central computer or server, for example, for review or analysis.

Furthermore, and for example, the data receipt capabilities may allow for the electronic display device and/or the CPU to receive software updates, apps, data or instructions from a central computer or server (for example a central computer or server operated by retail shop staff).

The CPU and/or the electronic display device may also include, and/or be in communication with, Wi-Fi and/or Bluetooth technology or capabilities, for example a wireless transceiver or IR port, to enable the wireless receipt and/or transmission of data or instructions to and/or from the electronic display device (or CPU).

In one embodiment, the Wi-Fi and/or Bluetooth technology or capabilities may be provided for elsewhere on the clothes hanger (that is, outside of the CPU), but nonetheless be in electronic communication with the CPU and/or the electronic display device.

Furthermore, the clothes hanger and/or the electronic display device may also include external ports where additional memory or software devices may be inserted, for example USB drives, memory sticks, SD memory cards, and so on.

In some embodiments the invention may also include a garment detection system, such as a garment load indication sensor. The garment detection system may be used to determine if a garment is actually being carried by the clothes hangar—and if not—the garment detection system may prevent the electronic display device from displaying the promotional and/or informational material.

Those skilled in the art will appreciate that a garment load indication sensor may be formed by a variety of different assemblies in numerous embodiments. For example, in one potential embodiment the clothes hanger may include load cell technology capable of measuring the weight of the clothes hangar when suspended from a support. In a further embodiment one or more surfaces of the clothes hangar may be used to mount photosensitive or photovoltaic elements. The covering of these elements will block the reception of environmental light indicating that the clothes hangar is loaded with a garment.

Preferably the loading state of the clothes hangar may be used by the CPU to determine if the electronic display device should be triggered.

In a preferred embodiment the clothes hanger may also include at least one display light. The triggering or activation of a display light may be controlled by the CPU depending on a number of potential variables. For example, in some instances the clothes hanger may also include one or more motion or proximity sensors deployed to detect the presence of a person in the vicinity of the clothes hangar. In such embodiments a light display may be presented to the person detected using the clothes hanger's display light or an array of display lights. These light displays may be formed by an array of LED light sources of various colours in one embodiment. Furthermore, the light display may also have various component lights turned off and on in any desired sequence calculated to attract attention.

In some embodiments the triggering of a light display may be inhibited based on the CPU assessing the state or condition recorded for the clothes hangar. For example, in some embodiments a light display may only be triggered while the clothes hangar is in a standby mode, and/or in a garment-loaded state.

In some embodiments the invention may also record customer data in the form of a record reflecting whether the clothes hangar is picked up immediately after performing a light display.

In one embodiment, the electronic display device may be adapted to activate automatically, for example upon a customer picking up the clothes hanger and/or removing the clothes hanger from the support means, such as a retail clothing rack.

In such an embodiment, and for example, the electronic display device and/or the CPU may automatically remain in a ‘stand-by’ mode when the clothes hanger is hanging on a clothing rack. However, when the clothes hanger is lifted from the rack the CPU and/or the electronic display device may be automatically activated via a control switch mechanism that may be in electronic communication with the electronic display device and/or the CPU. This switch mechanism may, for example, be a gravity based switch that may be located either at the base of the hanging means or, alternatively on the underside of the hanging means which maintains contact with the clothing rack. The weight of the clothes hanger may close the switch, but without the weight (that is, when the clothes hanger is lifted off the rack), the electronic display device and/or the CPU may be automatically activated to begin displaying the intended promotional and/or informational material to the customer.

Alternatively, the clothes hanger may incorporate a touch sensitive switch, or a proximity sensor switch (eg, using IR light), which can detect when the clothes hanger has been picked up or otherwise moved, and which may therefore automatically facilitate the display of the promotional and/or informational material.

In another embodiment, the electronic display device may be adapted to be activated manually by the customer. In such an embodiment, and for example, the customer may remove a clothes hanger from a clothing rack and examine the garment supported by the clothes hanger more closely. If the customer is interested in learning more about the garment, the customer may then manually activate the electronic display device, for example by the use of an “On” or “Start” button. It is also envisaged that the electronic display device could be activated manually by touch or by voice command.

In one embodiment, the operation of the electronic display device may be able to be controlled by the customer, whereby the customer is able to determine the type of promotional and/or informational material to be displayed on the electronic display device and/or choose between a range of viewing options.

For example, the electronic display device may utilise operational electronic buttons and/or touch screen technology, such as those utilised by other electronic devices such as smartphones, tablets, and portable music devices.

Preferably, the electronic display device may include a viewing screen for viewing images or video.

The viewing screen may be of any suitable form. Examples include viewing screens utilising LCD, LED and/or plasma technology.

The viewing screen may be of any size, as required or as desired, or as dictated by the size, shape or configuration of the clothes hanger and/or the neck portion associated with the clothes hanger. It is envisaged however that preferred sizes of the viewing screen may be in the range of 50-90 mm wide by 30-70 mm high.

In one embodiment, the viewing screen (and/or the electronic display device) may be located below the clothes hanger and/or the crossbar. For example, the viewing screen (and/or the electronic display device) may be attached to the bottom (and/or the crossbar) of the clothes hanger and hang below the clothes hanger. This is nonetheless still deemed to be in the region of the neck portion of the clothes hanger.

In one embodiment, the viewing screen may be a touchscreen, whereby the customer is able to interact with the electronic display device and/or control the type of promotional and/or informational material to be displayed by the electronic display device. That is, in such an embodiment, the electronic display device may be operated in substantially the same fashion as smart phones or tablets. For example, the electronic display device and/or the touchscreen may be provided with a menu which enables customers to choose and implement different viewing options (or material), as required or as desired.

In such an embodiment, a customer may be able to manually activate the electronic display device by touching the screen, after which the customer, may then be able to control the operation of the electronic display device, substantially as described above.

Preferably, the clothes hanger and/or the electronic display device may include audio output capabilities.

For example, a small speaker(s) may be provided on, or adjacent to, the electronic display device, or elsewhere on the clothes hanger.

In such an embodiment, the speaker may preferably be of a cone/bowl shape, which sits in a correspondingly-shaped moulding. This will ensure that the audio may be substantially directed towards the person utilising the clothes hanger. This may minimise any interference of sound between two clothes hangers playing side by side for different customers.

The clothes hanger and/or the electronic display device may also include an earphone socket for the attachment of headphones or portable earphones.

In one embodiment, it is envisaged that the electronic display device may only have audio output capabilities (rather than video or video/audio capabilities).

The electronic display device and/or the CPU may be powered by a battery or batteries. Such batteries may be rechargeable or replaceable.

If rechargeable, and for example, the clothes hanger may be adapted to automatically recharge the batteries when the clothes hanger is sitting in its resting position upon a clothing rack.

In one such embodiment the hanging means may define or provide two or more electrically isolated contacts. These contacts may be positioned or arranged so as to touch corresponding conductive elements of the support means, allowing an electric current to be supplied to the clothes hanger, in order to recharge its electrical components. For example, in one embodiment where garments are to be supported on a rail, the opposite sides of the rail may provide electrical contacts running the length of the rail, these contacts being positioned to touch two further contacts integrated within a hook hanging means. In such embodiments electrical contacts may be formed on an exterior surface of the hanging means with an insulated transport wire running from the contact to a further recharging circuit integrated into the clothes hanger.

Alternatively, the clothes hanger may be provided with an electrical port through which the battery may be recharged, via an electrical lead or USB cable (if appropriate).

In yet another embodiment, it is possible that the batteries could be recharged wireless and/or via inductive charging. An example of such an arrangement is described in PCT/US2010/056240.

The clothes hanger and/or the electronic display device may also carry a QR code which could provide additional capability for interaction with the customer, for example with devices such as smartphones.

The clothes hanger and/or the electronic display device may also incorporate or support inventory tracking and/or recording technology through links between the CPU and retailer barcodes or SKU numbers.

In use, once a clothes hanger has been lifted off a clothing rack, the electronic display device may be automatically or manually activated. Hence, within a few seconds of the customer lifting the clothes hanger off the clothing rack, the viewing screen (and/or the audio device) associated with the electronic display device may be utilised by the customer to display promotional and/or informational material.

Examples of possible promotional and/or informational material may include:
a) a sales promotional banner,
b) a slideshow of images (for example showing different colours of the garment supported by the clothes hanger and/or showing the garment being worn in different environments and/or by different models),
c) a short promotional clip of perhaps 10 to 30 seconds, which can provide information about the garment itself and/or the garment manufacturer,
d) other clothing items in the clothing range,
e) material designed simply to entertain the customer in any manner that the manufacturer or retailer may choose. For example, by the playing of a music video, and/or the showing of aesthetically pleasing geographical images such as mountains, forests, beaches, and/or or the playing of soothing sounds or music, and so on).

The customer may preferably be able to choose between different types of material to be displayed and/or choose between a range of viewing options for displaying the material. For example, the user may be able to pause or fast forward or rewind the promotional and/or informational material, for example by the use of electronic buttons or by manipulating the touchscreen (if applicable). Furthermore, the user may also be able to choose the length of time the material is displayed before ending the display and/or choosing another type of material to be displayed.

The garment manufacturer and/or retailer may upload to, and/or remove from, the electronic display screen and/or CPU, whatever promotional and/or informational material it wishes to be able to display to the customer. This material may be uploaded (or removed) wirelessly, for example by the use of a mobile phone network or via Wi-Fi or Bluetooth. It is also envisaged that a garment manufacturer and/or retailer may be able to wirelessly upload and/or remove (and/or edit) the relevant promotional and/or informational material to many (or all) clothes hangers at once, similar to how smartphone apps are updated for all users at once.

Alternatively and/or additionally, batches or predetermined groups of clothes hangers may be updated simultaneously, for example all those clothes hangers relating to a certain brand or style of dress etc.

The electronic display device and/or CPU may also be electronically updated, or have material added, edited or removed, manually, for example via USB ports, SD cards, flash drives, chip devices, and so on.

It is also envisaged that the material to be uploaded and/or removed from the electronic display device may be stored and/or transmitted to the electronic display device from a cloud computing system.

The garment manufacturer and/or the retailer may have the same promotional and/or informational material uploaded into batches of clothes hangers used for similar garments, for example for garments of a similar range, season or style. Alternatively, the garment manufacturer and/or the retailer may have specific promotional and/or informational material uploaded for each unique garment to be supported by the clothes hanger.

The CPU may preferably include a memory for storing and/or analysing and/or manipulating and/or transmitting any type of data or information gathered, including (but not limited to) inventory management data.

Furthermore, usage data may be recorded by the electronic display device and/or stored by the CPU which may show, for example, how many times the clothes hanger has been lifted off the clothing rack, how many views each promotional and/or informational material has had, and for how long, how many times the garment has been taken to a fitting cubicle (for example by the use of electronic recognition technology such as RFID tags and such like), how many times the promotional and/or informational material has been played, what parts were played, and/or whether the material was played in part or in full, whether or not the garment was purchased, how long the garment has remained on the clothing rack before being purchased, and so on.

It is also envisaged that any data stored on and/or collected by the electronic display device and/or the CPU (or memory associated with the CPU) may be erased as or when required. Moreover, new, or replacement, data, for example data relating to new promotional and/or informational material, may be subsequently uploaded to the electronic display device and/or the CPU, as or when required.

It is also envisaged that the clothes hanger may be fitted with a security device so that the clothes hanger may be protected against theft. For example, a clothes hanger may be fitted with a RFID device and the entrance/exit to a retail store may be fitted with a corresponding reader (similar to how many clothing retail stores currently operate to protect against clothing being stolen).

The clothes hanger may be constructed of any suitable material or materials, for example metal, wood, plastics, paper, cardboard or combinations of these materials. It is envisaged however that the clothes hanger could be manufactured most cost-effectively and in large numbers if the clothes hanger was comprised of a plastics material. It is also envisaged that the clothes hanger may be made, in whole or in part, of recyclable materials.

According to another aspect of the present invention, there is provided a clothes hanger, substantially as described above, wherein the electronic display device is releasably attached, or releasably attachable, to the clothes hanger.

In such an embodiment, the electronic display device may be removed from the clothes hanger for viewing by a customer. Once the customer has viewed the promotional and/or informational material, the electronic display device may then be reattached to the clothes hanger. Any suitable releasable attachment means may be utilised, for example a push fit and/or the use of releasable clips and/or a spring loaded push and release type mechanism.

In such an embodiment, the customer may decide to leave the clothes hanger on the clothing rack, or alternatively, the customer may remove the clothes hanger from the clothing rack and then remove the electronic display device from the clothes hanger.

In an alternative such embodiment, the hanging means may be adapted to be locked in place with respect to the support means whereby the customer is able to view the promotional and/or informational material on the electronic display device only by removing the electronic display device from the clothes hanger and bringing it towards them.

According to another aspect of the present invention, there is provided a clothes hanger, substantially as described above, wherein the electronic display device is releasably attached to the clothes hanger by a cord.

Preferably, the cord may be a retractable cord.

In such an embodiment, a customer may remove the electronic display device from the clothes hanger, whereby the promotional and/or informational material may be viewed close up—or held in a preferred orientation. It is also envisaged that the releasable nature of the electronic display device may allow for it to be held and/or orientated in any desired position, for example a customer may orientate the electronic display device so that he/she and a friend may both readily view the viewing screen of the electronic display device.

The retractable cord may preferably be an electronic retractable cord, whereby the electronic display device is still electrically or electronically connected to the clothes hanger.

In another such embodiment, the electronic display device may be removable from the clothes hanger, and be wirelessly connected (or connectable) to the clothes hanger (that is, without the need for a retractable cord).

In another embodiment, the hanging means may be in the form of a rod extending from the neck portion, with the distal end of the rod being provided with a lug for engaging with a corresponding hook which may be permanently attached to a support means. Such arrangements are commonly found in a hotel room closets and are designed to ensure that clothes hangers are not inadvertently stolen or taken. In such an embodiment, the hook will remain fixed to the support means when the remainder of the clothes hanger is removed from the hook. Such an embodiment does away with the requirement for a retractable cord, as described previously.

According to another aspect of the present invention, there is provided a clothes hanger, substantially as described above, wherein the electronic display device sits within a hollow compartment formed within the clothes hanger.

According to another aspect of the present invention, there is provided a clothes hanger, substantially as described above, wherein the clothes hanger is formed from a face plate and a back plate, the face plate and the back plate being connected, or connectable, to each other, to thus form the clothes hanger.

In such an embodiment, the face plate and the back plate may be formed separately, and joined together, to thus form the clothes hanger. In such an embodiment, the back plate and the face plate may preferably be releasably attachable to each other. For example, the face plate and the back plate may be adapted to be screwed or clipped together.

The face plate and/or the back plate may be provided with any type of graphics or other material. For example, a retail surfing shop may use face plates and/or back plates which include pictures of breaking waves, or beach views, or surfboards, and so on.

According to another aspect of the present invention, there is provided a clothes hanger, substantially as described above, wherein the face plate and/or the back plate include a compartment, the compartment being adapted to receive the electronic display device.

In such an embodiment, the electronic display device may preferably be adapted to be removably fitted within the compartment. In this fashion, a new or replacement electronic display device may be fitted within the compartment and/or to the clothes hanger, for example, if the previous electronic display device acquired a fault that was not able to be repaired.

The compartment may be provided with brackets, protrusions or lugs to define the region into which the electronic display device is to be fitted and/or to locate the electronic display device within the compartment.

Furthermore, the compartment may be provided with dampening means, for example a rubber, plastic or sponge material to protect the electronic display device, for example, should the clothes hanger accidentally be dropped.

According to another aspect of the present invention, there is provided a system for presenting items of clothing, said system including:
a) a support means,
b) at least one clothes hanger for supporting an item of clothing,
c) at least one hanging means for hanging said at least one clothes hanger from the support means,
d) an electronic display device located on, or attached to, one or more of said at least one clothes hanger, said electronic display device including a viewing screen adapted to display promotional and/or informational material.

According to another aspect of the present invention, there is provided a system for presenting items of clothing, substantially as described above, wherein the arrangement and construction is such that said electronic display device is adapted to be activated, or activatable, upon said at least one clothes hanger being removed from said support means by a user.

An advantage associated with the clothes hanger, and/or the system for presenting items of clothing, is that the electronic display device may be housed within each clothes hanger (or some, or most, clothes hangers—as required or desired), whereby each customer is able to readily and directly view the promotional and/or informational material on each clothes hanger (and associated garment) that they remove from a clothing rack. Such an arrangement has significant advantages over clothes hangers that merely transmit images to a shared and/or distant monitor in only the rough vicinity of the customer.

Furthermore, the promotional and/or informational material may be displayed more-or-less instantaneously for the customer in relation to each garment they are interested in, rather than having to wait for an adjacent (or distant) monitor to become available (whether or not the promotional and/or informational material is displayed automatically or manually by the customer). Moreover, no specialist equipment is required in order for the customer to be able to view the promotional and/or informational material, for example a specialist electronic reading gun or separate monitor.

### PREFERRED EMBODIMENTS

The descriptions of the preferred forms of the invention to be provided herein, and with reference to the accompanying drawings, are given purely by way of example, and are not to be taken in any way as limiting the scope or extent of the invention.

### DRAWINGS

FIG. 1: is a view of a clothes hanger, representing one possible embodiment of the present invention,

FIG. 2: is a view of another clothes hanger, representing another possible embodiment of the present invention, and

FIG. 3: is a view of a system for presenting items of clothing, which system incorporates the clothes hanger illustrated in FIG. 1.

### DESCRIPTION OF PREFERRED EMBODIMENT

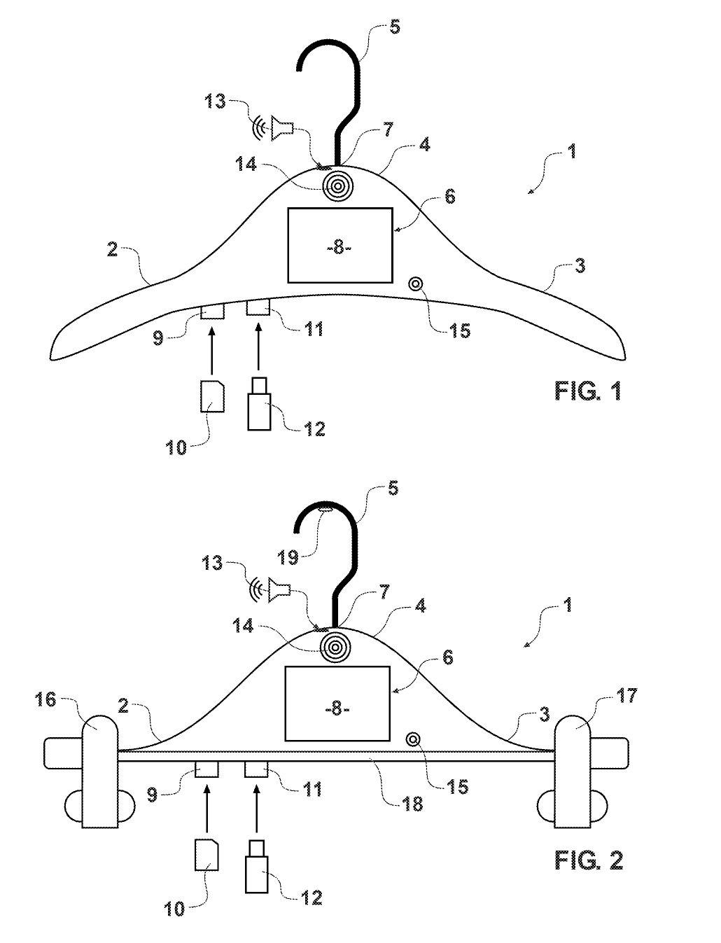

Having regard to FIG. 1, there is shown a clothes hanger, generally indicated by arrow 1.

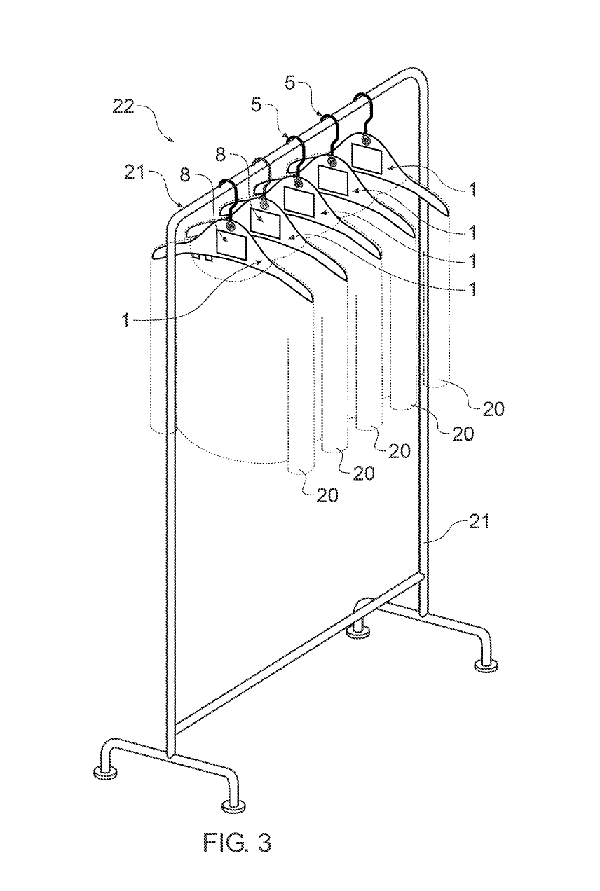

The clothes hanger 1 includes two arms 2,3 extending from a central neck portion 4. The arms 2,3 and neck portion 4, in combination, are adapted to support an item of clothing, such as a garment 20 (see FIG. 3).

The clothes hanger 1 also includes a hanging means in the form of a hook 5 for hanging the clothes hanger from a support means such as a retail clothing rack 21 (see FIG. 3).

The clothes hanger 1 also includes an electronic display device, generally indicated by arrow 6. The electronic display device 6 is located in the region of the central neck portion 4 of the clothes hanger 1, and includes a display screen 8 which is adapted to display promotional and/or informational material.

The arms 2,3 and neck portion 4 are integrally formed from a plastics material. The hook 5 is made of metal and, during manufacture, is subsequently connected to the top 7 of the neck portion 4.

The electronic display device 6 is fitted into a compartment (not shown) formed within the central neck portion 4. The electronic display device 6 may be secured within the compartment by any suitable means, for example adhesives, clamps, clips or screws.

The display screen 8 is a LCD screen, which is approximately 70 mm long by 50 mm high. The LCD screen 8 is a touchscreen.

The electronic display device 6 and/or the screen 8 is located and/or visible on only one side of the clothes hanger 1 (although in other embodiments the electronic display device 6 and/or the screen 8 may be located and/or visible on both sides of the clothes hanger 1).

The electronic display device 6 includes an internal CPU (not shown).

The CPU controls the overall functions and/or workings of the electronic display device 6, as well as the loading, playing, removal and overall use of the promotional and/or informational material to be displayed on the electronic display device 6.

The CPU also includes memory storing capabilities (not shown).

The CPU also includes a real-time clock (not shown).

The clothes hanger 1 also includes several external ports where additional memory devices may be inserted. That is, the clothes hanger 1 includes an SD port 9 for accepting an SD card 10. Furthermore, the clothes hanger 1 includes a USB port 11 for accepting a USB connector 12.

The SD card 10 and/or the USB connector 12 may also be used for adding, receiving or changing data or software relating to the electronic display device 6 and/or CPU. Furthermore, the SD card 10 and/or the USB connector 12 may be utilised for adding software or software updates to the electronic display device 6. Apps may also be added, upgraded and/or removed in this fashion.

The clothes hanger 1 also includes a wireless transceiver 13 which is housed within the top 7 of the neck portion 4. The wireless transceiver 13 may operate with a mobile phone network or Wi-Fi and/or Bluetooth technologies. The wireless transceiver 13 may also be used for adding, removing and/or transmitting and/or changing data relating to the electronic display device 6, as well as for adding software, software updates, and apps to the electronic display device 6.

The clothes hanger 1 also includes a small speaker 14 to provide the clothes hanger 1, and electronic display device 6, with audio capabilities. There is also provided a small earphone socket 15 to enable earphones to be inserted.

In the embodiment shown, the electronic display device 6 is adapted to be activated manually by the customer, that is, by virtue of customer interaction with the electronic display device 6 and/or the LCD touchscreen 8.

In use therefore, the customer may remove the clothes hanger 1 from a clothing rack 21 (see FIG. 3), if, for example, the customer is interested in looking more closely at the garment 20 supported by the clothes hanger 1. The customer may then manually activate the electronic display device 6 and/or the LCD touchscreen 8, for example by pushing an on/off button (not shown) and/or by touching the touchscreen 8. The customer may then use a menu associated with the touchscreen 8 to firstly view the type of material that may be chosen, and subsequently choose which promotional and/or informational material the customer wishes be displayed. The customer is also able to pause, stop and/or rewind the promotional and/or informational material as or when required or desired. The promotional and/or informational materials may be of different types, for example images, video and/or audio clips.

In this fashion, the operation of the electronic display device 6 is able to be manually activated and controlled by the customer, whereby the customer is able to determine the type of promotional and/or informational material to be displayed on the electronic display device 6 and/or choose between a range of viewing options.

The promotional and/or informational material may include photos or videos of the garment in different colours or sizes, or worn by a number of different models or in a number of different locations or social settings. Furthermore, the promotional and/or informational material may include information such as special discounts, details of the manufacturer, types of materials used in the garment, sizing, and/or any other material which the manufacturer and/or retailer may wish to convey to the customer.

The electronic display device 6 and/or the CPU (and/or the transceiver 13) also incorporate or support data collection, storage and/or data transmission capabilities, for example, for management or inventory tracking, for recording how many times the clothes hanger 1 has been lifted off the clothing rack, how many views the promotional and/or informational material has had and for how long, how many times the garment has been taken to a fitting cubicle, how many times the promotional and/or informational material has been played, and/or whether it was played in part or in full, whether or not the garment was purchased, how long the garment has remained on the clothing rack before being purchased, and so on.

FIG. 2 illustrates another possible embodiment of the clothes hanger 1. The essence of the invention illustrated in the clothes hanger 1 of FIG. 2 is substantially the same as that illustrated in FIG. 1, and for convenience only therefore the same numerals are used for the various common features of the clothes hanger 1 illustrated in FIG. 1.

In FIG. 2, the distal ends of the arms 2,3 are joined by a crossbar 18.

The crossbar 18 and/or the distal ends of the arms 2,3 are provided with clips 16,17 which may be utilised for clipping onto garments such as trousers.

The electronic display device 6 of the clothes hanger 1 of FIG. 2 is adapted to activate automatically upon a customer picking up the clothes hanger 1, and/or removing the clothes hanger 1 from the clothing rack 21 (see FIG. 3).

That is, the electronic display device 6 and/or the CPU may automatically remain in a ‘stand-by’ mode when the clothes hanger 1 is hanging on the clothing rack 21. However, when the clothes hanger 1 is lifted from the clothing rack 21, the CPU and/or the electronic display device 6 is automatically activated via the actuation of the control switch 19—which is in electronic communication with the electronic display device 6 and/or the CPU. This control switch 19 is a gravity based switch that is located on the underside of the hook 5 where the hook 5 maintains contact with the clothing rack 21. The weight of the clothes hanger 1 closes the switch 19, but without the weight (that is, when the clothes hanger 1 is lifted off the clothing rack 21), the switch 19 is automatically actuated, thus actuating the electronic display device 6 and/or the CPU—which may then automatically begin displaying the intended promotional and/or informational material to the customer (perhaps after a delay of a few seconds).

It is also envisaged that the clothes hanger 1 may include attributes of each of the embodiments illustrated in FIGS. 1 and 2. For example, the electronic display device 6 may be automatically activated as per the embodiment illustrated in FIG. 2, but the customer may nonetheless have the ability to interact with the electronic display device 6 (as per the embodiment illustrated in FIG. 1), but only if they wished to do so. Such an embodiment would allow for customers who are tech-savy (and who may therefore wish to choose/control what is shown) and customers who are less tech-savy and who may therefore prefer for the promotional and/or informational material to be continuously displayed automatically.

FIG. 3 illustrates a system, generally indicated by arrow 22, for presenting items of clothing such as garments 20, for sale in a retail environment. The clothes hangers 1 in FIG. 3 are all of the type illustrated in FIG. 1. And again, and for convenience only, the same numerals are used in FIG. 3 for the various common features of the clothes hangers 1 that are illustrated in FIG. 1.

In FIG. 3, there are shown five clothes hangers 1 hanging from a retail clothing rack 21. In practice, many more clothes hangers 1 could be hung from the clothing rack 21, but only five are shown for ease of illustration.

The system 22 illustrates how garments 20 may be presented in a retail clothing environment, utilising the clothes hangers 1. The customer, upon seeing a garment 20 that they like (on the clothing rack 21), may remove the clothes hanger 1 from the clothing rack 21 and have a closer look at the garment 20—to decide if they like the garment 20 and/or wish to try on, or purchase the garment 20. And the electronic display device 6 associated with each clothes hanger 1 may be actuated (manually in this case) to display promotional and/or informational material.

This has the effect of greatly enhancing the shopping experience for the customer, and hopefully result in the customer being more likely to purchase the garment 20 (or at least wish to try on the garment 20)—in view of the promotional and/or informational material which may be displayed via the electronic display device 6 and/or screen 8.

The clothes hanger 1 (illustrated in any of FIGS. 1, 2 and 3) may be manufactured, for example, by a company using independently manufactured electronics and plastic moulded components. Once manufactured the clothes hanger 1 may be shipped to a clothes hanger supplier (herein: “Supplier”). The Supplier may lease the clothes hanger 1 to a clothing manufacturer or retailer (collectively referred to herein as “Promoter”). The Promoter may then arrange to have the appropriate promotional and/or informational material or data loaded into each and every electronic display device 6 of the clothes hanger 1

The uses and applications of the clothes hanger 1 are numerous. Examples of three different scenarios showing how the clothes hanger 1 may be utilised are as follows:

### Scenario 1—Brand Promotion.

The Promoter may provide the Supplier with an electronic file containing the desired promotional and/or informational material, such as a promotional video clip or advertisement which the Supplier then uploads onto a portable memory card system such as SD Cards 10 and/or USB connectors 12. The material may then be uploaded to the clothes hanger 1, and/or the electronic display device 6, by the use of the SD port 9 and USB port 11 respectively, prior to the clothes hangers 1 being delivered to the Promoter.

Once a particular promotion has ended or new content is desired, the Promoter simply sends new promotional and/or informational material to the Supplier to be added to a new batch of clothes hangers 1, which are subsequently delivered to the Promoter, and the previous clothes hangers 1 are collected and/or stored by the Promoter. Alternatively, the previous promotional and/or informational material may be deleted by the Promoter and new content subsequently added.

For example Quicksilver® (a clothing company) could send retailers new stock deliveries matched with pre-programmed clothes hangers 1, containing a QR code to link to their new catalogue, and a video card which plays a video of a sponsored surfing event.

### Scenario 2—In Store—Retailer Promotion

A retailer may be given their own administration login capability to access a permanently embedded CPU or RAM memory unit in the clothes hanger 1 enabling the retailer to upload their own media content from their website, from the internet, or from a cloud computing facility, via Wi-Fi or Bluetooth connectivity. This allows the retailer to change and/or update the media content, as or when required or desired, and it also allows the retailer to operate the clothes hangers 1 as an extension, for example of their own website content or inventory management system.

A key use of this feature would be for in-store sales promotions.

For example the clothes hanger 1 could be used to display on screen banners which read “Buy this garment and get another FREE” or “Get a further 10% off the marked price” or “If you like this shirt you may also like the shorts to go with it—on sale in our menswear department—see picture which follows”.

Yet another use could be shopping mall management using the clothes hangers 1 in selected stores to advertise mall wide promotions. For example, an advertisement such as “Buy this item and get a free coffee and muffin at X Cafe”.

### Scenario 3—Customer Use Scenario

In addition to providing an immediate customer experience aimed at enhancing the appeal of the goods being held for view, the clothes hangers 1 may also carry ‘QR code’ technology which enables a potential buyer to upload and save a copy of the media displayed, website links, additional catalogue or pricing information or brand promotion media (for later enjoyment or information reference) via use of a smartphone device or laptop.

Additionally, Bluetooth capability built into the clothes hanger 1 will also enable a potential customer to electronically browse for goods while in store using their smartphone device.

An advantage associated with the clothes hanger 1 is that the electronic display device 6 is preferably housed within each and every clothes hanger 1, whereby each customer is able to readily and directly view the promotional and/or informational material on each clothes hanger 1 that they remove from a clothing rack 21. Such an arrangement has significant advantages over the prior art clothes hangers that merely transmit images to a shared monitor in the vicinity of the customer.

Furthermore, the promotional and/or informational material may be displayed instantaneously for the customer in relation to each garment they are interested in, rather than having to wait for an adjacent (or distant) monitor to become available (whether or not the promotional and/or informational material is displayed automatically or manually by the customer). Moreover, no specialist equipment is required in order for the customer to be able to view the promotional and/or informational material, for example a specialist electronic reading gun or separate monitor.

The operation of the electronic display device is also able to be controlled by the customer, whereby the customer is able to determine the type of promotional and/or informational material to be displayed on the electronic display device and/or choose between a range of viewing options.

### Variations

While the embodiments described above are currently preferred, it will be appreciated that a wide range of other variations might also be made within the general spirit and scope of the invention, and/or as defined by the appended claims.

1. A clothes hanger for supporting an item of clothing, said clothes hanger including:
a) two arms extending from a neck portion, said arms and/or neck portion being adapted, or able, to support said item of clothing,
b) a hanging means connected, or connectable, to the neck portion for hanging the clothes hanger from a support means,
c) an electronic display device located in the region of the neck portion of the clothes hanger, said electronic display device including a viewing screen adapted to display promotional and/or informational material,
the arrangement and construction being such that said electronic display device is adapted to be activated, or activatable, upon the clothes hanger being removed from said support means by a user.

2. A clothes hanger, as claimed in claim 1, wherein the clothes hanger is further provided with a crossbar extending between the distal ends of the two arms.

3. A clothes hanger, as claimed in claim 2, wherein the arms, neck portion and crossbar are formed from a single piece of material.

4. A clothes hanger, as claimed in claim 2, wherein the crossbar and/or the distal ends of the arms are provided with one or more clips for clipping onto the item of clothing to be supported.

5. A clothes hanger, as claimed in claim 1, wherein the electronic display device includes, or is in communication with, a central processing unit (CPU).

6. A clothes hanger, as claimed in claim 1, wherein the electronic display device is integrally formed with respect to the clothes hanger.

7. A clothes hanger, as claimed in claim 1, wherein the electronic display device is adapted to activate automatically upon a customer picking up the clothes hanger, and/or removing the clothes hanger, from the support means.

8. A clothes hanger, as claimed in claim 1, wherein the electronic display device is adapted, or able, to be activated manually by a customer.

9. A clothes hanger, as claimed in claim 1, wherein the operation of the electronic display device is able to be controlled by the customer, whereby the customer is able to determine the type of promotional and/or informational material to be displayed on the electronic display device and/or choose between a range of viewing options.

10. A clothes hanger, as claimed in claim 9, wherein the viewing screen is a touchscreen.

11. A clothes hanger, as claimed in claim 1, wherein the clothes hanger and/or the electronic display device includes audio output capabilities.

12. A clothes hanger, as claimed in claim 1, wherein the clothes hanger and/or the electronic display device includes data collection capabilities.

13. A clothes hanger, as claimed in claim 1, wherein the clothes hanger and/or the electronic display device includes data receipt and/or data transmission capabilities.

14. A clothes hanger, as claimed in claim 1, wherein the clothes hanger and/or the electronic display device includes a wireless transceiver.

15. A clothes hanger, as claimed in claim 1, wherein the promotional and/or informational material to be displayed by the electronic display device relates to the item of clothing supported by the clothes hanger.

16. A clothes hanger, as claimed in claim 1, wherein the support means is a clothing rack.

17. A clothes hanger, as claimed in claim 1, wherein the hanging means is a hook.

18. A clothes hanger, as claimed in claim 1, wherein the electronic display device includes a rechargeable battery.

19. A clothes hanger as claimed in claim 16, wherein the hook includes two or more electrically isolated contacts adapted to engage with corresponding conductive elements of the clothing rack, to enable the recharging of the rechargeable battery.

20. A clothes hanger as claimed in claim 18, wherein the battery is adapted to be recharged wirelessly and/or via inductive recharging.

21. A clothes hanger as claimed in claim 1, wherein the clothes hanger further includes a detection system for determining if an item of clothing is being supported by the clothes hanger.

22. A clothes hanger as claimed in claim 1, wherein the clothes hanger further includes a proximity sensor to detect if a person is in the vicinity of the clothes hanger.

23. A clothes hanger as claimed in claim 22, wherein the proximity sensor is adapted to activate a display light or lights if a person is detected as being in the vicinity of the clothes hanger.

24. A clothes hanger, as claimed in claim 1, wherein the electronic display device is releasably attached, or releasably attachable, to the clothes hanger.

25. A clothes hanger, as claimed in claim 24, wherein the electronic display device is releasably attached to the clothes hanger by a retractable cord.

26. A clothes hanger, as claimed in claim 1, wherein the hanging means is adapted to be fixed to the support means, and the remainder of the clothes hanger may be removed from the hanging means and/or support means.

27. A system for presenting items of clothing, said system including:
a) a support means,
b) at least one clothes hanger for supporting an item of clothing,
c) at least one hanging means for hanging said at least one clothes hanger from the support means,
d) an electronic display device located on, or attached to, one or more of said at least one clothes hanger, said electronic display device including a viewing screen adapted to display promotional and/or informational material.

28. A system for presenting items of clothing, as claimed in claim 27, wherein the arrangement and construction is such that said electronic display device is adapted to be activated, or activatable, upon said at least one clothes hanger being removed from said support means by a user.

29. A clothes hanger, substantially as herein described, and with reference to the accompanying drawings.
